(19) United States
(12) Patent Application Publication
(10) Pub. No.: US 2022/0237234 A1
(43) Pub. Date: Jul. 28, 2022

(54) DOCUMENT SAMPLING USING PREFETCHING AND PRECOMPUTING

(71) Applicant: Microsoft Technology Licensing, LLC, Redmond, WA (US)

(72) Inventors: Omar Emad Eldin AHMED, Cairo (EG); Mina M. MIKHAIL, Bothell, WA (US)

(21) Appl. No.: 17/155,496

(22) Filed: Jan. 22, 2021

(51) Int. Cl. G06F 16/93; G06N 20/00; G06K 9/62; G06F 16/22

(52) U.S. Cl. CPC G06F 16/93; G06F 16/2282; G06K 9/6259; G06N 20/00

(57) ABSTRACT

A system to facilitate document sampling may include a sampling service engine coupled to a document data store that contains a set of unlabeled documents. The sampling service engine may include local storage and a prefetching component to download a subset of the documents from the document data store before completion of an executing Machine Learning (“ML”) model training process. The prefetching component may also store the subset of the documents in the local storage. A precomputing component may execute a sampling algorithm on the stored subset of the documents and select viable documents for user-provided labels based on ML model prediction scores and at least one sub-sampling type. The document data store and the sampling service engine might, in some embodiments, execute in a cloud computing environment.

### BACKGROUND

A Machine Learning (“ML”) model may be trained using a set of labeled documents. In many cases, however, only unlabeled documents may be available (e.g., thousands or millions of unlabeled documents). A user may then label some of those documents to assist the ML model training. Determining which documents would be most efficiently labeled by the user is referred to as “document sampling.” For example, having the user redundantly label a large number of similar documents might not be very helpful for the ML model training process. What is needed are systems and methods to accurately and efficiently improve document sampling.

### SUMMARY

This summary is provided to introduce a selection of concepts in a simplified form that are further described below in the detailed description section. This summary is not intended to identify all key or essential features of the claimed subject matter, nor is it intended as an aid in determining the scope of the claimed subject matter.

Systems, methods, and computer readable storage devices embodying instructions for improved document sampling are provided herein. In some embodiments, a system to facilitate document sampling includes a sampling service engine coupled to a document data store that contains a set of unlabeled documents. The sampling service engine may include local storage and a prefetching component to download a subset of the documents from the document data store before completion of an executing ML model training process. The prefetching component may also store the subset of the documents in the local storage. A precomputing component may execute a sampling algorithm on the stored subset of the documents and select viable documents for user-provided labels based on ML model prediction scores and at least one sub-sampling type. The document data store and the sampling service engine might, in some embodiments, execute in a cloud computing environment.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

FIG. 1 is a typical ML model creation method.

FIG. 2 is a high-level block diagram of a system to facilitate document sampling according to some embodiments.

FIG. 3 is a flowchart of a method to facilitate document sampling in accordance with some embodiments.

FIG. 4 is a more detailed view of a system to facilitate document sampling according to some embodiments.

FIG. 5 is an overall data flow in accordance with some embodiments.

FIG. 6 is a document labeling display in accordance with some embodiments.

FIG. 7 is a prefetching method according to some embodiments.

FIG. 8 is a precomputing method in accordance with some embodiments.

FIG. 9 is a sampling method according to some embodiments.

FIG. 10 is a more detailed system architecture in accordance with some embodiments.

FIG. 11 illustrates a document manifest according to some embodiments.

FIG. 12 is a still more detailed view of a cloud-based architecture in accordance with some embodiments.

FIG. 13 is a block diagram illustrating example physical components of a computing device in accordance with some embodiments.

FIG. 14 is a portion of a results table according to some embodiments.

FIG. 15 illustrates an overall system in accordance with some embodiments.

FIG. 16 is an overall method according to some embodiments.

FIG. 17 is a block diagram of a distributed computing system in accordance with some embodiments.

### DETAILED DESCRIPTION

The following description is provided to enable any person in the art to make and use the described embodiments. Various modifications, however, will remain readily apparent to those in the art.

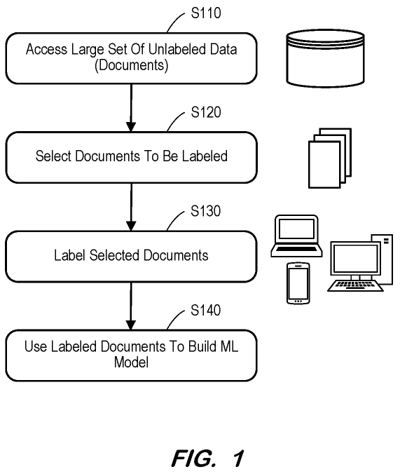

In the process of building custom document classification/extraction machine learning models, a user may be presented with the problem of having a very large number of unlabeled data elements. For example, FIG. 1 is a typical ML model creation method were a large set of unlabeled documents is accessed at S110. A mechanism may be utilized to help the user choose documents to label from the pile of unlabeled ones efficiently such that the user needs to label as few labels as possible to obtain a high-quality model (as opposed to labeling everything). In particular, at S120 the system may use “document sampling” to select a subset of the documents to be labeled. As used herein, the phrase “document sampling” may refer to a process to efficiently obtain unlabeled documents for the user to build/improve a classification/extraction model. According to some embodiments, document sampling may include an algorithm (such as diversity sampling) to help ensure that the chosen documents will result in a well-balanced and efficient model. The sampling algorithm may use an already existing ML model to make predictions against the unlabeled documents and apply constraints to results of those predictions to select samples. This approach is also known as “active learning.” Note that other options may be associated with cold starting (e.g., without an existing ML model), such as random sampling, text search sampling, etc.

The selected documents may then be labeled at S130, and the labeled documents can be used in a training process to build the ML model at S140. Note that when the unlabeled documents are stored in external storage (e.g., via blob storage in the AZURE® computing environment available from MICROSOFT®), sampling algorithms may be bottle-necked by Input Output (“IO”) limitations and it can take a substantial amount of time to obtain the required samples. Note that most algorithms need to scan the documents and apply certain filters/constraints to decide whether or not each document is a viable sample. If the documents that pass those constraints are not abundant in the unlabeled data, the system may need to scan a substantial number of documents to get the appropriate samples for labeling by the user. As a result, typical ML model training approaches can introduce technical deficiencies, including substantial network traffic to scan the documents, large storage requirements, increased processing resources, etc.

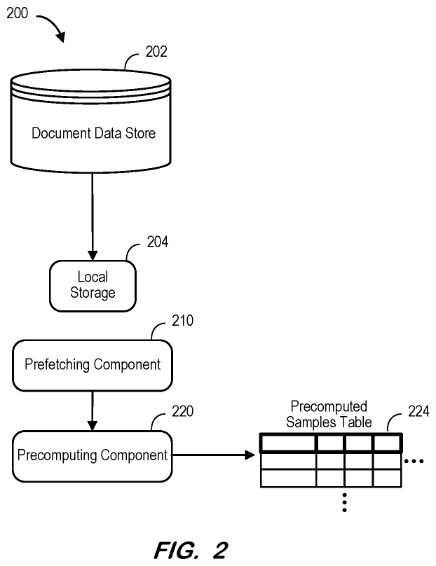

To improve document sampling, FIG. 2 is a high-level block diagram of a system 200 that introduces prefetching and precomputing capabilities according to some embodiments of the present invention. As a result of the prefetching and/or precomputing, prior art technical deficiencies may be reduced, such as by reducing network traffic, decreasing storage requirements, improved processing resources, etc. The system 200 may include a document data store 202 that contains a large number of unlabeled documents. As used herein, the term “documents” might refer to various types of data files such as text documents, image files, audio recording, etc. Information may be moved from the document data store 202 to “local” storage 204 (e.g., local to a document sampling process). According to some embodiments, a prefetching component 210 and a precomputing component 220 may work together to update a precomputed samples table 224 (that can then be used to facilitate a document sampling process) to help create a “machine learning” model. As used herein, the phrase “machine learning” may refer to any approach that uses statistical techniques to give computer systems the ability to learn (i.e., progressively improve performance of a specific task) with data without being explicitly programmed. Examples of machine learning may include decision tree learning, association rule learning, artificial neural networks deep learning, inductive logic programming, Support Vector Machines (“SVM”), clustering, Bayesian networks, reinforcement learning, representation learning, similarity and metric learning, sparse dictionary learning, genetic algorithms, rule-based machine learning, learning classifier systems, etc.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The prefetching component 210 and/or precomputing component 220 may store information into and/or retrieve information from various data sources, such as the local storage 204 and precomputed samples table 224. The various data sources may be locally stored or reside remote from the prefetching component 210 and/or precomputing component 220. Although a single prefetching component 210 and precomputing component 220 are shown in FIG. 2, any number of such devices may be included. Moreover, various devices described herein might be combined according to embodiments of the present invention. For example, in some embodiments, the local storage 204 and prefetching component 210 might comprise a single apparatus. The prefetching component 210 and/or precomputing component 220 functions may be performed by a constellation of networked apparatuses in a distributed processing or cloud-based architecture.

A user may access the system 200 via remote monitoring devices (e.g., a Personal Computer (“PC”), tablet, smartphone, or remotely through a remote gateway connection) to view information about and/or manage data center operation in accordance with any of the embodiments described herein. In some cases, an interactive graphical display interface may let a user define and/or adjust certain parameters (e.g., prefetching or precomputing constraints such as a maximum number of documents or a request timeout) and/or provide or receive automatically generated recommendations or results from the system 200.

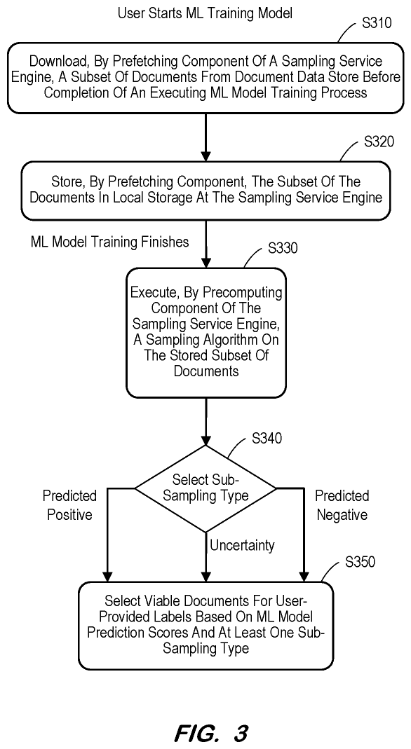

FIG. 3 is a flowchart of a method to facilitate document sampling in accordance with some embodiments. Note that the flowcharts described herein do not imply a fixed order to the steps, and embodiments of the present invention may be practiced in any order that is practicable. Also note that any of the methods described herein may be performed by hardware, software, or any combination of these approaches. For example, a computer-readable storage medium may store thereon instructions that when executed by a machine result in performance according to any of the embodiments described herein.

Note that the method may begin when a user starts training a ML model, and a prefetching component may begin to download documents to local disk. In particular, at S310, the prefetching component of a sampling service engine may download a subset of documents from a document data store before completion of the executing ML model training process. The document data store may, according to some embodiments, contain a set of unlabeled documents. At S320, the prefetching component may store the subset of the documents in local storage at the sampling service engine. According to some embodiments, the prefetching component may be associated with a maximum number of documents, a maximum download timeout, etc. Note that the prefetching component may trigger additional downloads of documents from the document data store responsive to the consumption of documents (e.g., the additional downloads might be triggered when a number of unconsumed documents in a precomputed samples tables falls below a threshold value). After the ML model training finishes, a precompute component may use the freshly trained ML model to make predictions against the documents downloaded by the prefetching component. Note that the precompute component may initially notify the prefetching component to stop downloading after a pre-determined number of documents have been downloaded (e.g., a configurable threshold set at 500 documents). At S330, a precomputing component of the sampling service engine may execute a sampling algorithm on the stored subset of the documents. The sampling algorithm may, for example, utilize a proprietary process such as diversity sampling as a parent sampling type to ensure that the chosen documents will result in an appropriate model. According to some embodiments, a diversity sampling algorithm may randomly select and utilize one or more sub-algorithms at S340, such as Predicted Positive (“PP”) sampling, Predicted Negative (“PN”) sampling, and Uncertainty (“UN”) sampling. Of the locally stored downloaded documents, the system might select, for example, only 50 samples and save information about those documents to a table that contains the precomputed samples.

The PP sampling sub-algorithm might, for example, supply samples that are above a decision boundary (e.g., samples scoring more 0.5) while the PN sampling sub-algorithm supplies samples that are below a decision boundary (e.g., samples scoring less than 0.5). As used herein, the phrase “decision boundary” may refer to a configurable decimal number used to make sample decisions (e.g., set to 0.5 with samples higher than the boundary being positive and lower than the boundary being negative). The UN sampling sub-algorithm may use PP and PN sampling to determine an uncertainty range (e.g., a range of scores where the system is uncertain if a sample is +ve or −ve (e.g., samples scoring from 0.4 to 0.6). Note that the diversity sampling algorithm might randomly select a sub-algorithm (e.g., with an equal probability that each one might be selected). The score used by the sampling service to perform operations may be the result of a model prediction score (the model for which the system is sampling). Note that for the sampling service, the model itself may be considered a black box. The system may use the model's wrapper to pass text to the model and retrieve scores. Such an approach may provide a relatively fast and effective way to comb through those scores and determine the best candidates (samples).

Alternating between the different sub-sampling types may improve the ML model because the system will sometimes return a sample that is positive (and can either confirm or reject that categorization). Similarly, a negative sample may provide valuable information as well as a sample that the system is unsure if it qualifies as positive or negative. Moreover, randomization in every step may provide a good distribution of labels for the ML model, since the system is not ingesting the data in the same order that it is provided (and each request would result in a completely different set of samples). At S350, the precomputing component may select viable documents for user-provided labels based on ML model prediction scores and at least one sub-sampling type.

If the precompute component selects PP sampling, it processes documents in a random order and selects documents with a prediction score more than 0.5 as a viable sample. If the precompute component selects PN sampling, it processes documents in a random order and selects documents with a prediction score less than 0.5 as a viable sample. If the precompute component selects UN sampling, it internally re-uses PP and PN to calculate dynamic thresholds (e.g., between 0.4 and 0.6). In this way, UN sampling internally uses PP and PN information to see how much positive and negative samples can be obtained from the downloaded documents. If the ratio is 50:50, then the model is balanced and the uncertainty is close to none. If the ratio is 60:40, on the other hand, the dynamic range may be shifted towards the positive (e.g., between 0.5 and 0.7).

Note that that labels for the chosen documents might or might not efficiently result in an appropriate model (e.g., a document that is very similar to other documents that have been already labeled may be less likely to be useful as compared to another document). Assume, for example, that users add the best possible labels to the samples that are selected. The sampling service may supply the user with different types of documents, such as: documents that have a positive prediction score, documents that have a negative prediction score, and documents that have an uncertain prediction score. Alternating between positive and negative results may result in a more equally distributed and balanced model. For example, if the system only selects positive examples, all of the prediction scores will be positive. Note that there is a certain balance the system should maintain to improve uncertainty boundaries. As used herein, the phrase “uncertainty boundaries” may refer to two decimal numbers that are dynamically calculated using an input model to determine an uncertain range of scores. For example, in a well-balanced model the uncertainty boundary might be 0.4 to 0.6 while in a model shifted towards positive values the uncertainty boundary might be 0.4 to 0.7. A similar problem might arise if the system only selects negative examples. Note that uncertainty may help the model generally, the more labels users provide for uncertain documents will result in a more robust and accurate ML model. Generally, to determine how “good” a model is the system should use a test set of documents that is blind (that is, the documents were not used to train the model) and diverse (the set contains documents that represent the full spectrum of the model). The system can then calculate an accuracy score (e.g., the F1 score) to determine how good the model is. Note that sampling might not calculate the accuracy of the model, instead sampling might just provide a method that is considered indicative model accuracy. Calculating the accuracy score can be as simple as the number of correctly predicted documents divided by the number of total predicted documents. Note, however, that there are a number of different metrics that measure the accuracy of a model, such as the F1 score which can be calculated as follows:

$$F 1 = \frac{2}{{recall}^{1} + {precision}^{- 1}} = 2 \frac{precision \cdot recall}{precision + recall} = \frac{TP}{TP + \frac{1}{2} ( FP + FN )}$$

Where TP indicates true positives, FP indicates false positives, and FN indicates false negatives. Note that embodiments might be configured to either achieve a balanced model or the system may try to achieve a model that is “good enough.”

In the “good enough” approach, the system might execute PP sampling a few times and evaluate the returned prediction scores. For example, if most of the documents returned have prediction scores that are relatively high (e.g., 0.93 or higher), then the system may assume that the model is positive. Note that this approach might not be definitive but may be used to estimate how good (or bad) a model is. Note that a “well-balanced” model may refer to a model whose scores are not shifted towards either positive or negative (e.g., a model trained with only negative examples will predict all not-previously-seen documents as negative and vice-versa). On the other hand, sampling measures how positive the returned positive results are (and, theoretically, the same can be applied with negatives). The higher the positives scores and the lower the negatives score (i.e., further away from the uncertainty range), the better the model is.

According to some embodiments, the precompute component may have a requirement that the ML training is complete and a trained model exists and is ready to use (that is, the precompute may execute after ML model training is finished and not before). If the model is not yet trained, the system may return random samples.

The precomputing component may, in some embodiments, store the results of the sampling algorithm in a precomputed samples table. Note that the sampling algorithm might be associated with diversity sampling, active learning, cold start random sampling, cold start text search sampling, etc. According to some embodiments, the document data store and/or the sampling service engine execute in a cloud computing environment. Moreover, some embodiments may include a sampling component to consume documents for labeling by a user based on information in the precomputed samples table.

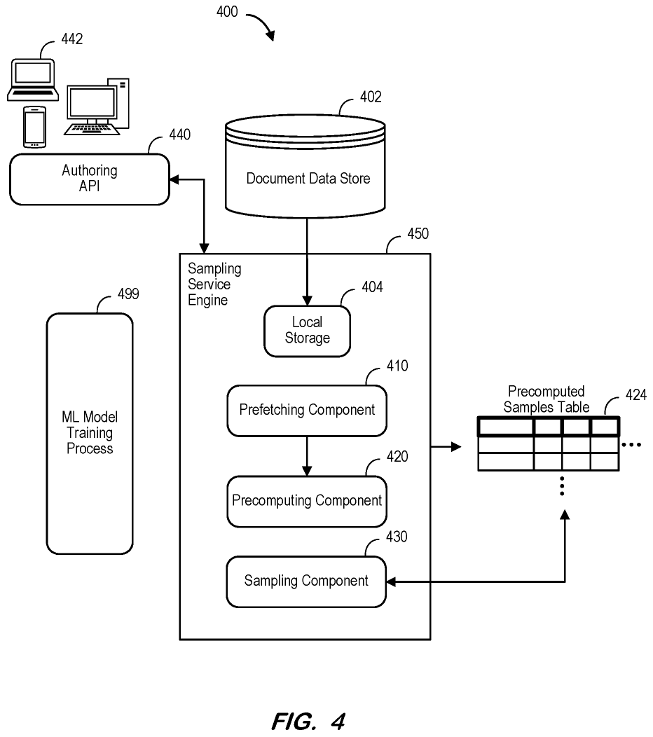

FIG. 4 is a more detailed view of a system 400 to facilitate document sampling according to some embodiments. As before, the system 400 may include a document data store 402 that contains a large number of unlabeled documents. Information, including document contents, may be moved from the document data store 402 to “local” storage 404 at a sampling service engine 450. According to some embodiments, the sampling service engine 450 exchanges information with an authoring Application Programming Interface (“API”) 440 (e.g., associated with user document labeling devices 442) and updates a precomputed samples table 424. The precomputed samples table 424 can then be used by a sampling component 430 to assist a ML model training process 499 to help create a ML model.

The authoring API 440 may be associated with an authoring service that is used to create models, rename, edit, add/edit/remove features, request training, etc. According to some embodiments, a sampling request (e.g., containing a model identifier and a requested number of samples) is sent to the sampling service through the authoring API 440. The authoring API 440 may then add the request to a queue that is listened to by the sampling service engine 450. When a user document labeling device 442 requests training, the authoring API 440 adds a message to a training queue. Before training starts, the authoring API 440 adds a request in a prefetching queue to start downloading documents. After training finishes, the authoring API 440 is notified about the event and, as a result, adds a request to a queue listed to by the precomputing component 420 (which waits for perfecting to finish and then starts computing scores using the freshly trained model). Through the authoring API 440, the user can either check the sampling operation status or retrieve the sampling results. The sampling service engine 450 saves the operation metadata in a Non-Structured Query Language (“NoSQL”) table and stores the operation results in a similar table (which may be accessed by both the authoring API 440 and the sampling service engine 450). After training completes, the system 400 may package and store the model (e.g., in an AZURE® blob store or via any other storage method). The model may then be loaded from storage by the sampling service engine 450 for the precomputing component 420. Note that a training process might not in direct contact with the sampling service engine. Instead, the authoring API 440 may act as a gateway between various internal services and contain all of the customer-facing APIs.

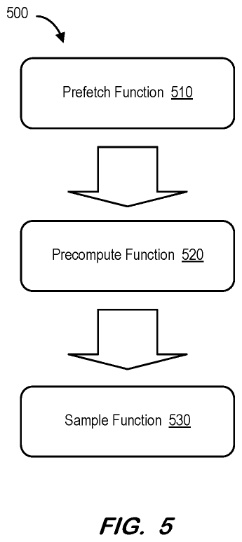

FIG. 5 is an overall data flow 500 in accordance with some embodiments. A prefetch function 510 downloads documents from a user unlabeled data store and store them to a local disk temporarily. A precompute function 520 may execute a sampling algorithm on the downloaded documents and store the results in a table (e.g., an AZURE® table or any other table store). A sample function 530 may then search for stored samples for a given model and return the stored samples if found. If nothing appropriate is found, the system may return random samples as a fallback option. Thus, some embodiments may be tightly coupled with the model training process resulting in improved ML model training. Note that model training may be a somewhat lengthy process. Before first time training is complete (that is, the system does not yet have a model to make predictions), the prefetching function 510 may download documents to disk and make use of the time (that the user is already waiting for the training to finish). When the training eventually finishes, the system may signal the prefetching function 510 to stop downloading documents.

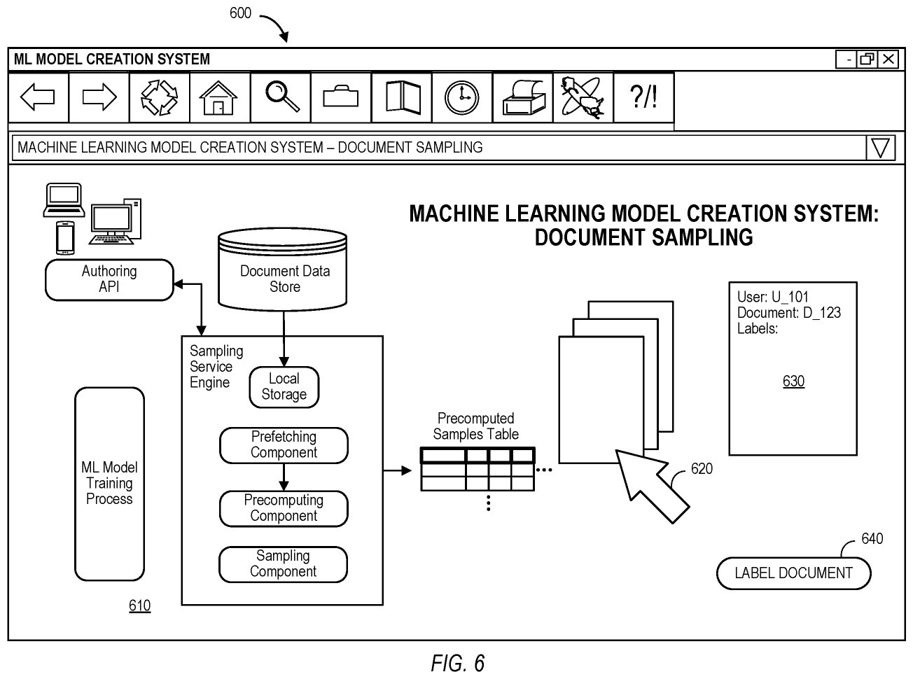

A user may view and/or adjust parameters associated with a document sampling system in accordance with any of the embodiments described herein. For example, FIG. 6 is a document labeling display in accordance with some embodiments. The display 600 includes graphical elements 610 representing document sampling system in accordance with any of the embodiments described herein. Selection of various elements 610 (e.g., via a touchscreen or computer mouse pointer 620) may result in a display of additional details about that element 610 (e.g., via popup window) and/or provide the user with a chance to alter or adjust properties of that element 610. For example, the user might adjust model parameters, add new data stores, update sampling constraints, etc. The display 600 further includes a data entry area 630 that can be utilized by the user to enter one or more labels for the automatically selected documents via activation of a “Label Document” graphical icon 640.

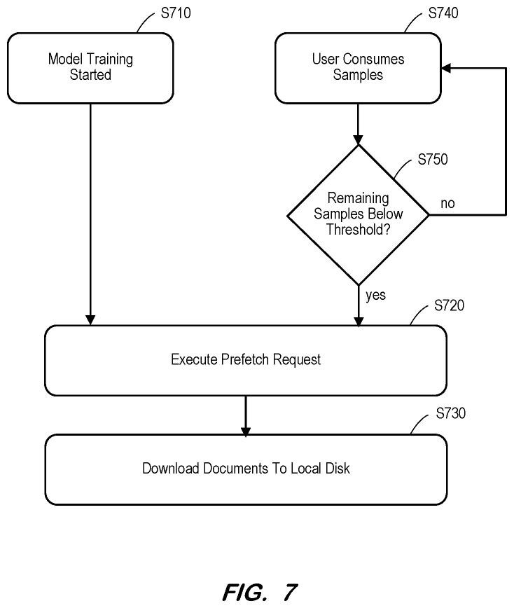

FIG. 7 is a prefetching method according to some embodiments. The prefetching method may download unlabeled documents and store them temporarily on a local disk serialized in a single file for use by a precompute function. In some embodiments, the prefetching function has constraints to ensure that it downloads enough documents. Note that the specific parameters associated with various constraints may be configurable and might need calibration depending on user behavior. In one embodiment, a request cannot be gracefully cancelled before it downloads a minimum number of documents (e.g., 500 documents). In still another embodiment, the system's prefetching functions can prefetch documents until a maximum number of documents (e.g., 2000 documents) have been downloaded. In yet another embodiment, a request has a timeout that overrides all other constraints to avoid system resource overutilization (e.g., 30 seconds).

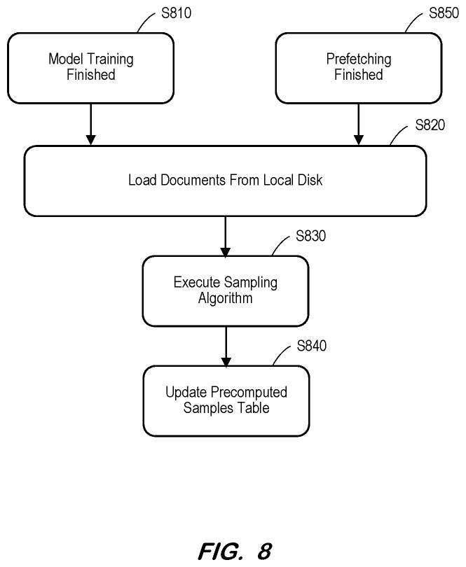

Note that the prefetching may be triggered, in some embodiments, by one or more events. In one embodiment, the prefetching functions are initiated in response to: (1) the start of model training and (2) user sample consumption. Upon detection of the first event, specifically, when model training starts at S710 for a given model or group of models, prefetching is performed at S720 to start downloading documents to local disk storage at S730 (e.g., by a prefetching component of a cloud computing environment). When training is finished, a precomputing method is triggered (as described with respect to FIG. 8) which in turn checks for the prefetching status (e.g., by a precomputing component of a cloud computing environment). If prefetching is complete, the precompute operations start. If prefetching is not yet completed, then the system may in some embodiments issue a cancellation of prefetching (honoring the constraints) and wait for the cancellation to complete (e.g., a status is updated to “finished”).

Upon detection of the second event, specifically a user sample consumption event in which a user consumes one or more samples from the stored samples in the precomputed samples table at S740, a prefetch request may be triggered at S720 if the remaining stored samples is less than a specific threshold for a given model at S750 (e.g., 200 documents). In this case, the prefetch component does not cancel the prefetching request. Instead, it downloads as much as possible up to the maximum limit (e.g., 2000 documents) and starts the precompute request.

FIG. 8 is a precomputing method in accordance with some embodiments. This function may load the downloaded documents from local disk and execute a sampling algorithm on those documents to retrieve a number of samples that are not above a specific threshold (e.g., 50 documents) in accordance with a precomputing constraint. Note that it may be time consuming to execute the algorithms on all documents. Instead, the system may save time and processing resources by only running until it has 50 samples. At that point, the system may stop and store those results in the precomputed samples table. The precompute function may also be responsible for initiating prefetch cancellation (and waiting for the cancelation to be complete before starting the precomputing logic). According to some embodiments, the precompute method has a timeout to avoid overutilizing system resources (e.g., 60 seconds). The precompute method may be triggered, according to some embodiments, by one of two triggers: (1) model training completion and (2) prefetch completion. After model training is finished at S810, the system may load documents from local disk storage at S820 and execute sampling algorithms at S830. The system may then update the precomputed samples table at S840. With the prefetch completion trigger, when prefetching is finished at S850 (triggered by sample consumption), the system may load documents from local disk storage at S820 and the process may continue.

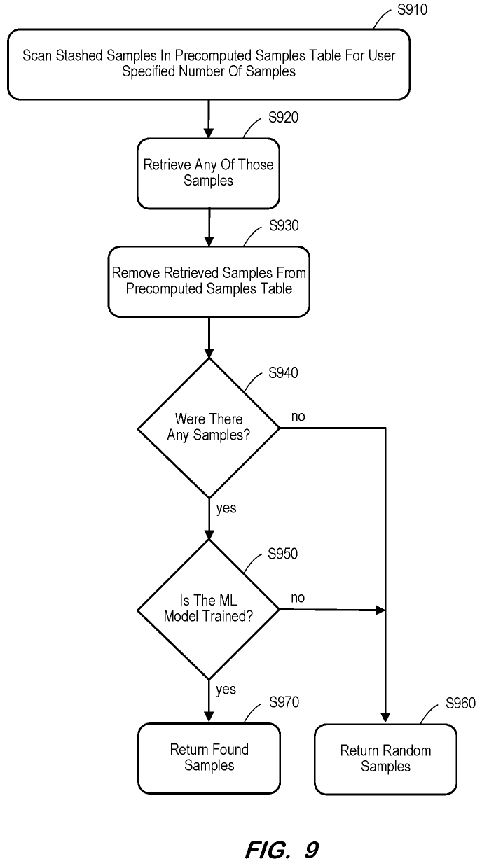

FIG. 9 is a sampling method according to some embodiments. This function, given a certain model, may scan stored samples in a precomputed samples table for a user-specified number of samples at S910. At S920, the system may retrieve those samples and remove them from the table at S930. If the number of samples found was more than zero (but less than the requested samples) at S940, the system may still return what was found at S970. If the system determines that the number of stored samples in the precomputed samples table is less than a specific threshold (e.g., 200 documents), the system may issue a new prefetching request only if the model is trained at S950 (which in turn issues a new precompute request when it finishes). The function will return random samples at S960 when it cannot find any stored samples at S940 or if the model is not trained at S950.

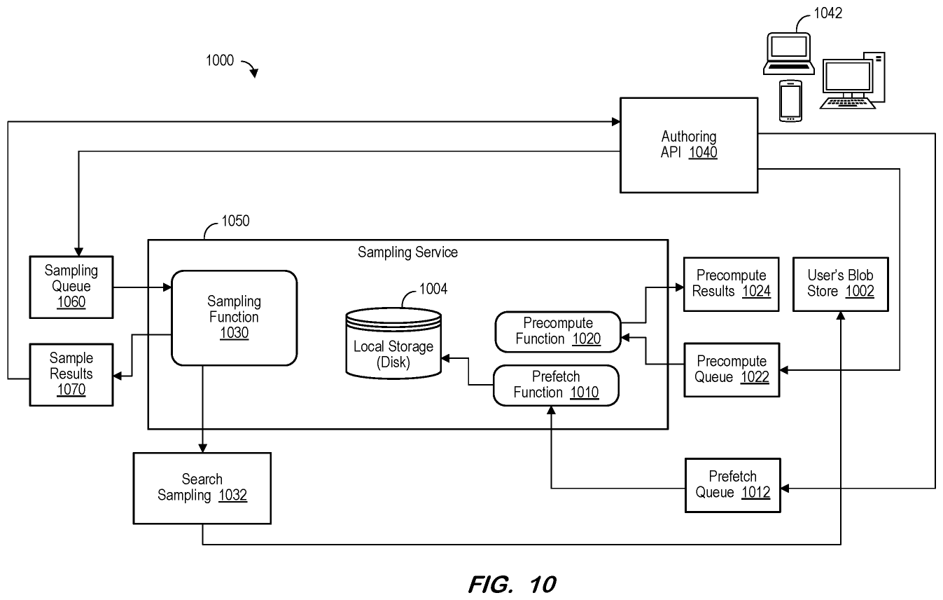

FIG. 10 is a more detailed view of a cloud-based architecture 1000 in accordance with some embodiments. An authoring API 1040 (e.g., associated with user document labeling devices 1042) may indicate that training has started which causes a prefetch function 1010 in a sampling service 1050 to begin prefetching via a prefetch queue 1012. Documents may then be copied from a user's blob storage 1002 to local disk storage 1004 at the sampling service 1050. A precompute queue 1022 may receive an indication that training has ended from the authoring API 1040 and a precompute function 1020 may update precompute results 1024. A sampling function 1030 may get unlabeled documents from the user's blob store 1002 via a search sampling element 1032. The sampling function 1030 may also send a sample signal to the authoring API 1040 via sample results 1070 and receive return sample results (e.g., document labels) via a sampling queue 1060.

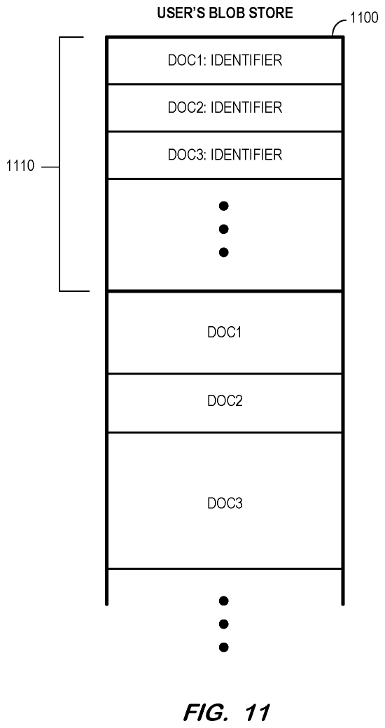

According to some embodiments, a manifest data structure is created, by a manifest caching function, containing a list of a set of unlabeled documents in a document data store. For example, FIG. 11 illustrates a document manifest 1110 in a user's blob store 1100 according to some embodiments. Note that a sampling process may need to constantly list items in a data source. Moreover, listing for most external storage is relatively slow and expensive to constantly use. The manifest 1110 solves this problem by having a data structure that indicates a list of valid documents in the user unlabeled document store (which then gets saved under a known name,). As a result, any time a sampling process needs to list/count available items it can download and use the manifest 1110. The manifest 1110 may be cached on a local sampling disk, and get periodically invalidated (e.g., every 6 hours) or whenever a manifest 1110 with a more recent “modified date” exists in the user store. The manifest 1110 might, for example, be used when random sampling accesses the manifest 1110 to get random document identifiers (to be labeled by a user). The manifest 1110 might also, for example, be used when prefetching accesses the manifest 1110 to know which documents should be downloaded.

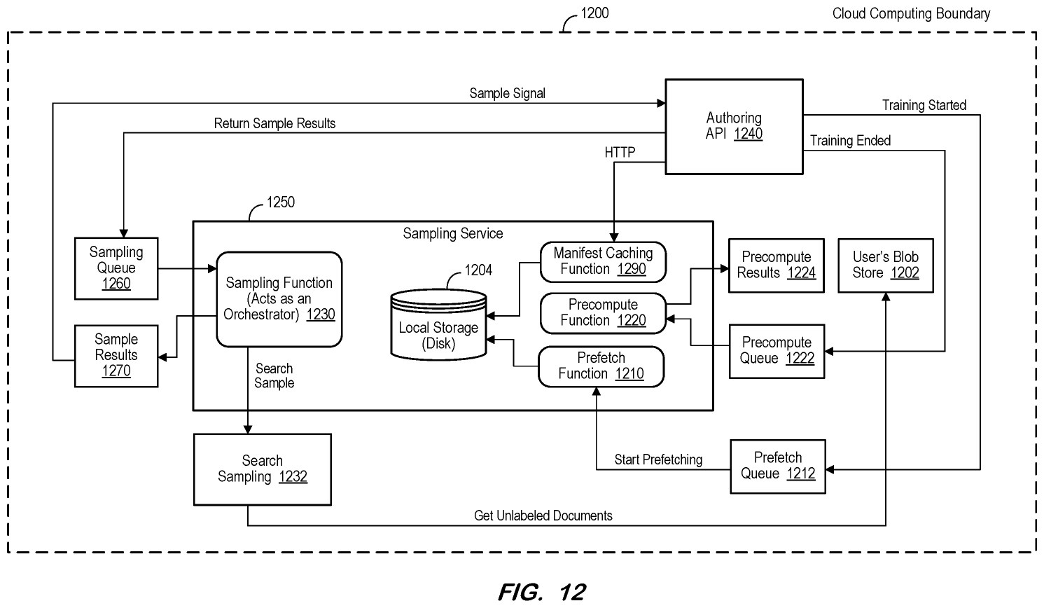

FIG. 12 is a still more detailed view of a cloud-based architecture 1200 in accordance with some embodiments. An authoring API 1240 (e.g., a cloud service associated with a natural language model) may indicate that training has started which causes a prefetch function 1210 in a sampling service 1250 to begin prefetching via a prefetch queue 1212. Documents may then be copied from a user's blob storage 1202 to local disk storage 1204 at the sampling service 1250. In some embodiments, the authoring API 1240 may also issue an HTTP command to a manifest caching function 1290 that stores a manifest in local disk storage 1204 as described with respect to FIG. 11. A precompute queue 1222 may receive an indication that training has ended from the authoring API 1240 and a precompute function 1220 may update precompute results 1224. A sampling function 1230 (acting as an orchestrator) may get unlabeled documents from the user's blob store 1202 via a search sampling element 1232. The sampling function 1230 may also send a sample signal to the authoring API 1240 via sample results 1270 and receive return sample results (e.g., document labels) via a sampling queue 1260.

While some implementations will be described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

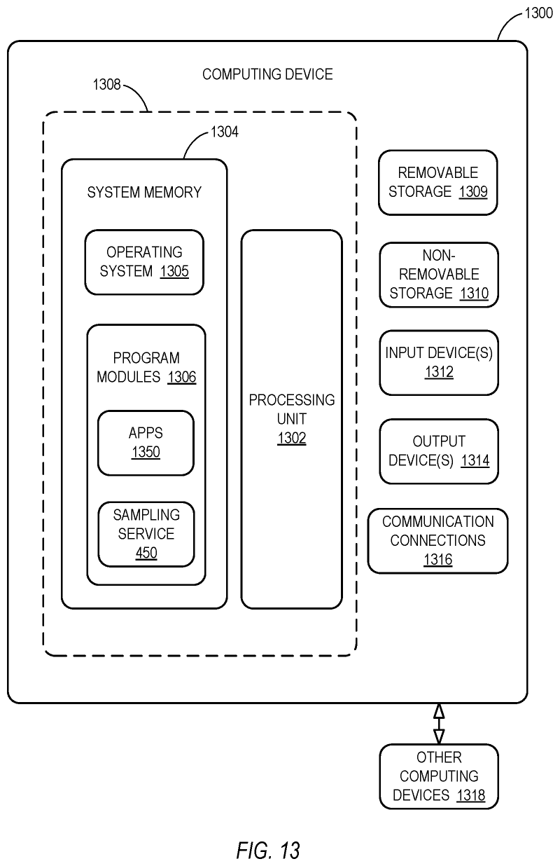

FIG. 13 and the associated description provide a discussion of a variety of operating environments in which examples are practiced. However, the devices and systems illustrated and discussed with respect to FIG. 13 are for purposes of example and illustration and are not limiting of a vast number of computing device configurations that are used for practicing aspects, described herein.

FIG. 13 is a block diagram illustrating physical components (i.e., hardware) of a computing device 1300 with which examples of the present disclosure may be practiced. In a basic configuration, the computing device 1300 includes at least one processing unit 1302 and a system memory 1304. According to an aspect, depending on the configuration and type of computing device, the system memory 1304 comprises, but is not limited to, volatile storage (e.g., random access memory), non-volatile storage (e.g., read-only memory), flash memory, or any combination of such memories. According to an aspect, the system memory 1304 includes an operating system 1305 and one or more program modules 1306 suitable for running software applications 1350. According to an aspect, the system memory 1304 includes the sampling service 450 in accordance with any of the embodiments described herein. The operating system 1305, for example, is suitable for controlling the operation of the computing device 1300. Furthermore, aspects are practiced in conjunction with a graphics library, other operating systems, or any other application program, and are not limited to any particular application or system. This basic configuration is illustrated in FIG. 13 by those components within a dashed line 1308. According to an aspect, the computing device 1300 has additional features or functionality. For example, according to an aspect, the computing device 1300 includes additional data storage devices (removable and/or non-removable) such as, for example, magnetic disks, optical disks, or tape. Such additional storage is illustrated in FIG. 13 by a removable storage device 1309 and a non-removable storage device 1310.

As stated above, according to an aspect, a number of program modules and data files are stored in the system memory 1304. While executing on the processing unit 1302, the program modules 1306 perform processes including, but not limited to, one or more of the stages of the method illustrated in FIG. 3. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 1300 has one or more input device(s) 1312 such as a keyboard, a mouse, a pen, a sound input device, a touch input device, etc. The output device(s) 1314 such as a display, speakers, a printer, etc. are also included according to an aspect. The aforementioned devices are examples and others may be used. According to an aspect, the computing device 1300 includes one or more communication connections 1316 allowing communications with other computing devices 1318. Examples of suitable communication connections 1316 include, but are not limited to, Radio Frequency (“RF”) transmitter, receiver, and/or transceiver circuitry; Universal Serial Bus (“USB”), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (i.e., memory storage.) According to an aspect, computer storage media include RAM, ROM, Electrically Erasable Programmable Read-Only Memory (“EEPROM”), flash memory or other memory technology, CD-ROM, Digital Versatile Disks (“DVD”) or other optical storage, magnetic cassettes, magnetic tape, magnetic disk storage or other magnetic storage devices, or any other article of manufacture which can be used to store information and which can be accessed by the computing device 1300. According to an aspect, any such computer storage media are part of the computing device 1300. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, RF, infrared, and other wireless media.

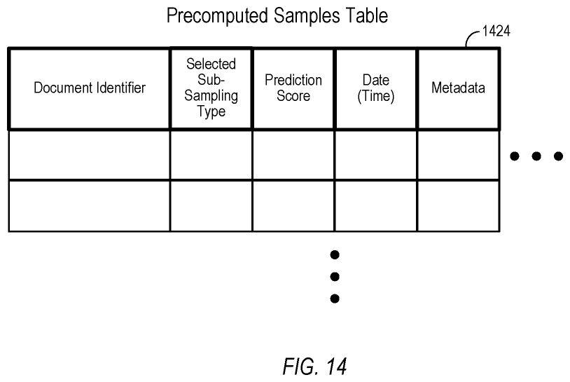

FIG. 14 is a portion of a results or precomputed table 1424 according to some embodiments. The precomputed samples table 1424 might be updated, for example, via a precomputing component. The precomputed samples table 1424 might include a document identifier, a selected sub-sampling type, and a ML model prediction score.

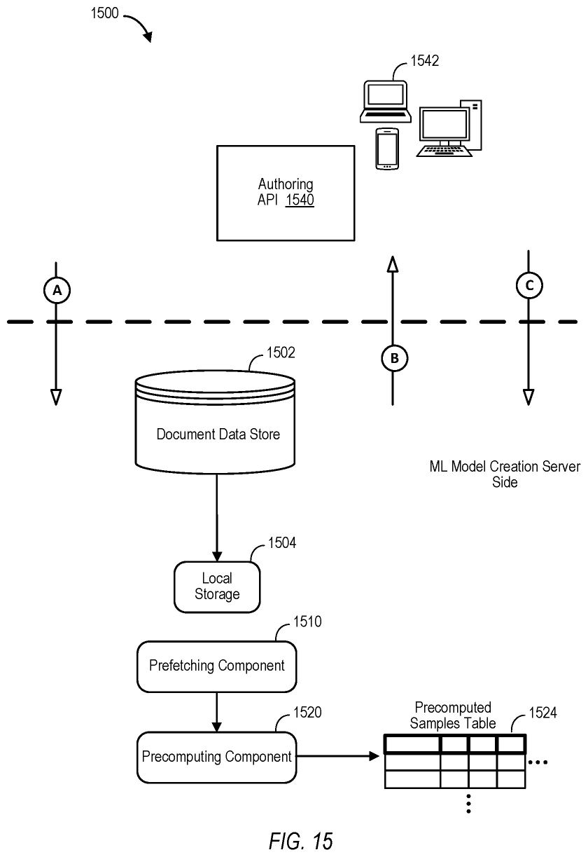

FIG. 15 illustrates an overall system 1500 in accordance with some embodiments. The system 1500 includes an authorizing API 1540 associated with user document labeling devices 1542 and a ML model creation server side (separated by a dashed line in FIG. 15). The ML model creation server side includes a document data store 1502 that contains a large number of unlabeled documents. Information may be moved from the document data store 1502 to “local” storage 1504 (e.g., local to a document sampling process). According to some embodiments, a prefetching component 1510 and a precomputing component 1520 may work together to update a precomputed samples table 1524 (that can then be used to facilitate a document sampling process) to help create or adjust a ML model. In particular, at (A) the authoring API 1540 might initiate model training. The ML model creation server side might then prefetch and precompute unlabeled documents and send some of the documents (e.g., the documents judged to be the most likely to be useful) to the document labeling devices 1542 at (B). A user may utilize the document labeling devise 1542 to label the documents and those labels may be returned at (C) to the ML model creation server side (e.g., to help train the ML model).

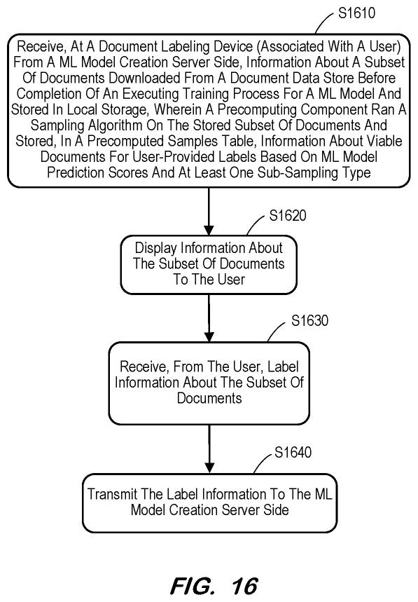

FIG. 16 is an overall method according to some embodiments. At S1610, a document labeling device associated with a user may receive, from a ML model creation server side, information about a subset of documents. The subset of documents may have been, for example, downloaded from a document data store before completion of an executing training process for a ML model and stored in local storage. Moreover, a precomputing component on the ML model creation server side may have executed a sampling algorithm on the stored subset of the documents and stored, in a precomputed samples table, information about viable documents for user-provided labels based on ML model prediction scores and at least one sub-sampling type. At S1620, the document labeling device may display information about the subset of documents to the user. At S1630, the system may receive, from the user, label information about the subset of documents (e.g., via data entry area 630 as described with respect to FIG. 6). At S1640, the system may transmit the label information to the ML model creation server side.

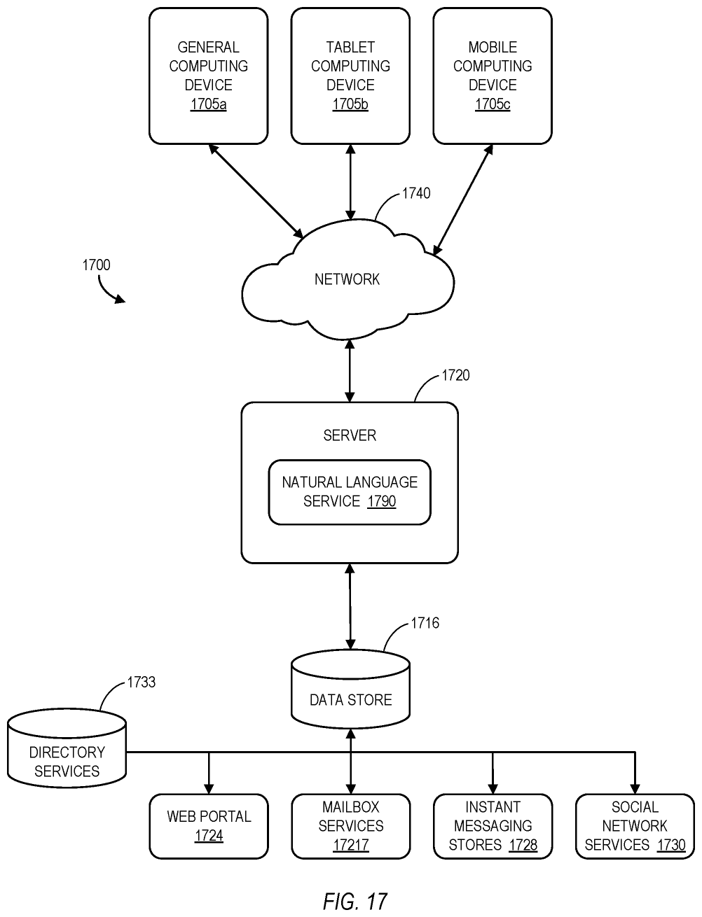

Note that embodiments described herein may be used to facilitate model training for many different types of systems. For example, the document sampling techniques might be used in connection with applications, bots (e.g., that use natural language learning to communicate with customers), Internet of Things (“IoT”) devices, etc. FIG. 17 is a block diagram of a distributed computing system 1700 associated with a natural language service 1790 trained using the sampling service engine 450 in accordance with some embodiments. Content developed, interacted with, or edited in association with the sampling service engine 450 in accordance with any of the embodiments described herein is enabled to be stored in different communication channels or other storage types. For example, various documents may be stored using a directory service 1722, a web portal 1724, a mailbox service 1726, an instant messaging store 1728, or a social networking site 1730. The natural language service 1790, trained in accordance with any of the embodiments described herein, may be operative to use any of these types of systems or the like to perform functions of the system 1700. According to an aspect, a server 1720 provides the natural language service 1790 in accordance with any of the embodiments described herein to clients 1705a, 1705b, 1705c. As one example, the server 1720 is a web server providing the natural language service in accordance with any of the embodiments described herein over the web. The server 1720 provides the natural language service 1790, trained in accordance with any of the embodiments described herein, over the web to clients 1705 through a network 1740. By way of example, the client computing device is implemented and embodied in a personal computer 1705a, a tablet computing device 1705b, or a mobile computing device 1705c (e.g., a smart phone), or other computing device. Any of these examples of the client computing device are operable to obtain content from the data store 1716.

Thus, embodiments may let a customer build efficient, high-quality ML classification and extraction models in less time, and with higher efficiency, as compared to traditional methods. Moreover, embodiments may provide a relatively high probability to be able to find required samples within latency requirements (e.g., within 1 second). In addition, embodiments may leverage time wasted by a user who is waiting for another lengthy operation (model training) to complete and provide consistent performance across different unstructured data storage solutions. The reuse of downloaded documents (prefetch downloads documents once) lets the recompute function use the same documents to predict for any number of different models (without the need to redownload anything from external storage). High resilience against failures may be achieved using the constraints on the prefetching and precomputing functions to avoid overutilization of system resources, external service failures (e.g., training failing to signal prefetch to stop a download), logical failures (e.g., invalid data sets in which it may be impossible to find samples), etc. Some embodiments may provide a highly scalable solution because it is separated into three logical units (as described with respect to FIG. 5), and the system might scale only those units that have relatively high resource consumption (without scaling the others).

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

What is claimed is:

1. A system to facilitate document sampling through prefetching and precomputing documents, comprising:
a sampling service engine, coupled to a document data store that contains a set of unlabeled documents, the sampling service engine including:
local storage,
a prefetching component to:
download a subset of the documents from the document data store before completion of an executing Machine Learning (“ML”) model training process, and
store the subset of the documents in the local storage, and
a precomputing component to execute a sampling algorithm on the stored subset of the documents and select viable documents for user-provided labels based on ML model prediction scores and at least one sub-sampling type.

2. The system of claim 1, wherein the at least one sub-sampling type includes at least one of: (i) predicted positive, (ii) predicted negative, and (iii) uncertainty.

3. The system of claim 1, further comprising:
the document data store containing the set of unlabeled documents.

4. The system of claim 3, wherein the document data store and the sampling service engine execute in a cloud computing environment.

5. The system of claim 1, wherein the prefetching component is associated with at least one of: (i) a maximum number of documents, and (ii) a maximum download timeout.

6. The system of claim 1, wherein the precomputing component stores information about the viable documents in a precomputed samples table.

7. The system of claim 6, wherein the sampling algorithm is associated with at least one of: (i) diversity sampling, (ii) active learning, (iii) cold start random sampling, and (iv) cold start text search sampling.

8. The system of claim 6, further comprising:
a sampling component to consume documents for labeling by a user based on information in the precomputed samples table.

9. The system of claim 8, wherein the prefetching component triggers additional downloads of documents from the document data store responsive to the consumption of documents.

10. The system of claim 9, wherein the additional downloads are triggered when a number of unconsumed documents in the precomputed samples table falls below a threshold value.

11. The system of 1, wherein a manifest data structure is created containing a list of the set of unlabeled documents in the document data store.

12. The system of claim 1, wherein the sampling service engine is associated with at least one of: (i) applications, (ii) bots, and (iii) Internet of Things (“IoT”) devices.

13. A computer implemented method to facilitate document sampling through prefetching and precomputing documents, comprising:
downloading, by a computer processor of a prefetching component of a sampling service engine, a subset of documents from a document data store before completion of an executing Machine Learning (“ML”) model training process, the document data store containing a set of unlabeled documents;
storing, by the prefetching component, the subset of the documents in local storage at the sampling service engine;
executing, by a precomputing component of the sampling service engine, a sampling algorithm on the stored subset of the documents; and
selecting, by the precomputing component, viable documents for user-provided labels based on ML model prediction scores and at least one sub-sampling type.

14. The method of claim 13, wherein the document data store and the sampling service engine execute in a cloud computing environment.

15. The method of claim 13, wherein the precomputing component stores information about the viable documents in a precomputed samples table.

16. The method of claim 15, wherein the sampling algorithm is associated with at least one of: (i) diversity sampling, (ii) active learning, (iii) cold start random sampling, and (iv) cold start text search sampling.

17. The method of claim 16, further comprising:
a sampling component to consume documents for labeling by a user based on information in the precomputed samples table.

18. The method of claim 17, wherein the prefetching component triggers additional downloads of documents from the document data store responsive to the consumption of documents.

19. The method of 13, further comprising:
creating a manifest data structure that contains a list of the set of unlabeled documents in the document data store.

20. A system to facilitate creation of a Machine Learning (“ML”) model, comprising:
a document labeling device associated with a user, including
a computer processor, and
a computer memory, coupled to the computer processor, storing instructions that when executed by the computer processor cause the document labeling device to:
(i) receive, from a ML model creation server side, information about a subset of documents, the subset of documents having been downloaded from a document data store before completion of an executing training process for a ML model and stored in local storage, wherein a precomputing component on the ML model creation server side ran a sampling algorithm on the stored subset of the documents and stored, in a precomputed samples table, information about viable documents for user-provided labels based on ML model prediction scores and at least one sub-sampling type,
(ii) display information about the subset of documents to the user,
(iii) receive, from the user, label information about the subset of documents, and
(iv) transmit the label information to the ML model creation server side.

21. The system of claim 19, wherein the transmission of label information by the document labeling device triggers prefetch and precompute processing on the ML model creation server side.
